(19) United States
(12) Patent Application Publication
(10) Pub. No.: US 2007/0163553 A1
(43) Pub. Date: Jul. 19, 2007

(54) Automobile fuel economizer

(75) Inventor: Mei-Hwa Chen, Taipei City (TW)

Correspondence Address: BIRCH STEWART KOLASCH & BIRCH, PO BOX 747, FALLS CHURCH, VA, 22040-0747, US

(73) Assignee: CONPLUX DEVELOP CO., LTD.

(21) Appl. No.: 11/334,396

(22) Filed: Jan. 19, 2006

(51) Int. Cl. F02M 27/00

(52) U.S. Cl. 123/538

(57) ABSTRACT

The present invention discloses an automobile fuel economizer for reducing the gas consumption of an automobile, and the automobile fuel economizer is form of a box body attached onto an automobile fuel tank, wherein the box body contains a substance having a far infrared property, such that the gas molecules in the fuel tank can exist in a state of being conducted by far infrared radiant energy for a long time, and thus the gas molecules become finer and smaller, and the gas can be combusted and utilized completely. The substance having a far infrared property contained in the box body passes through the fuel tank, so that gas molecules can absorb sufficient far infrared radiant energy, and thus achieving the purposes of reducing gas consumption, lowering air pollution, enhancing horsepower, and preventing carbon deposition.

### FIELD OF THE INVENTION

The present invention relates to an automobile fuel economizer, and more particularly to a box body that can be used with a fuel tank of an automobile.

### BACKGROUND OF THE INVENTION

Far infrared light is an invisible light occurred at the longest section of wavelength of an infrared light, which is considered as an electromagnetic wave having a strong penetrating capability and a large radiating force and capable of producing the high-frequency far infrared light and providing the significant temperature control and resonance effects. The far infrared light is capable of penetrating a pipe wall and being absorbed easily by an object and converted into the internal energy of the object, so as to produce heat energy to be dispersed outward.

At present, far infrared lights can be used for automobiles, and the properties including the wavelength and frequency of far infrared light make the gas molecules finer and smaller and greatly improve the gas combustibility, such that gas can be combusted and utilized completely, and the instability of various fuel combustions can be eliminated. Thus, the far infrared light allows automobile engines to maximize the horsepower and achieve the effects for protecting environment, reducing fuel consumption, lowering air pollution, enhancing horsepower, and preventing carbon deposition.

An “Automobile pipeline insulated catalytic pipe structure” disclosed in R.O.C. Pat. No. M277849 is a plastic casing pipe having cut stitches penetrating through both ends and the plastic casing pipe is made of a mixture of plastic and far infrared materials. With the cut stitches, a pipeline can be connected easily and quickly, and an insulating effect can be achieved. The far infrared light can be emitted to catalyze and activate copper molecules in an electric copper wire and fuel molecules in a fuel pipe.

Further, an “Automobile fuel economizer” disclosed in R.O.C. Pat. No. M279732 is integrally formed by a plastic medium, and the plastic medium comprises far infrared particles, and the automobile fuel economizer is in form of a pipe, such that the plastic medium has a connecting hole penetrating through both ends and a cut groove disposed on a side of the connecting hole. The cut groove can be spread open to elastically wrap the connecting hole around the external periphery of the fuel pipe, and the plastic medium includes a flexible member to be inserted conveniently by its flexibility into the connecting hole to adjust the diameter of the connecting hole and fit fuel pipes of different specifications.

In view of the “Automobile pipeline insulated catalytic pipe structure” and the “Automobile fuel economizer” provided for wrapping the external periphery of a fuel pipe, the effect of the far infrared light makes the gas molecules finer and smaller when the gas molecules pass through the fuel pipe, so that the gas molecules can be combusted completely to achieve the effect of reducing gas consumption. Since the function of the fuel pipe is primarily for supplying gas, therefore the gas will be sent to the engine and combusted to produce energy, when the fuel still has not been affected completely by the far infrared radiation. As a result, the performance of the automobile pipeline insulated catalytic pipe structure and the automobile fuel economizer is restricted.

Referring to R.O.C. Pat. No. M273629, a “Fuel tank casing sticker having the function of reducing gas consumption of an automobile” is a slice member made of a far infrared material and attached onto the automobile fuel tank for providing an effect of saving fuel for the automobile. Since the sticker comes with a thin slice member and the quantity of the included far infrared material is very limited, therefore the effect of conducting far infrared radiation on the gas molecules in the fuel tank is also limited. On the other hand, the sticker is limited by the technology related to the thin design, and the variety of applied substances is restricted, and thus increasing the costs.

### SUMMARY OF THE INVENTION

The primary objective of the present invention is to overcome the foregoing shortcomings and avoid the existing deficiencies by providing an automobile fuel economizer for reducing the gas consumption of an automobile, and the automobile fuel economizer is in form of a box body attached onto an automobile fuel tank, and the box body contains a substance having a far infrared radiant property, but not limited to such arrangement. The gas molecules in the fuel tank can exist in a state of being conducted by far infrared radiant energy for a long time, and thus the gas molecules become finer and smaller, and the gas can be combusted and utilized completely. The form of the box body can be adjusted according to the specification of the fuel tank and the accommodating space of the automobile. The substance having a far infrared property contained in the box body passes through the fuel tank, so that gas molecules can absorb sufficient far infrared radiant energy, and thus achieving the purposes of reducing gas consumption, lowering air pollution, enhancing horsepower, and preventing carbon deposition.

Further, the automobile fuel economizer of the present invention can add a catalyst in the box body for catalyzing the substance having a far infrared property and expediting the process of making the gas molecules finer and smaller.

### BRIEF DESCRIPTION OF THE DRAWINGS

FIG. 1 is a perspective view of the present invention;

FIG. 2 is a cross-sectional view of a preferred embodiment of the present invention;

FIG. 3 is a cross-sectional view of a preferred embodiment of the present invention;

FIG. 4 is a cross-sectional view of a preferred embodiment of the present invention;

FIG. 5 is a cross-sectional view of a preferred embodiment of the present invention; and

FIG. 6 is a schematic view of an automobile fuel economizer being applied to a fuel tank of an automobile according to a preferred embodiment of the present invention.

### DETAILED DESCRIPTION OF THE PREFERRED EMBODIMENTS

The present invention will now be described in more detail hereinafter with reference to the accompanying drawings as follows:

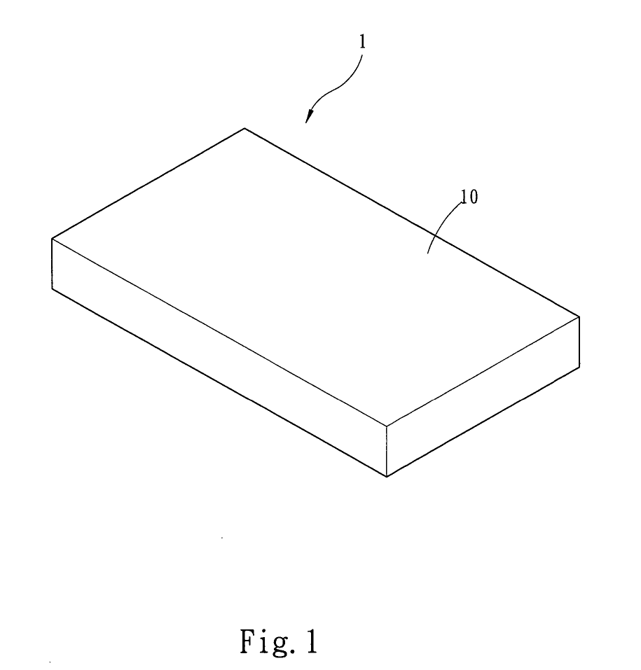

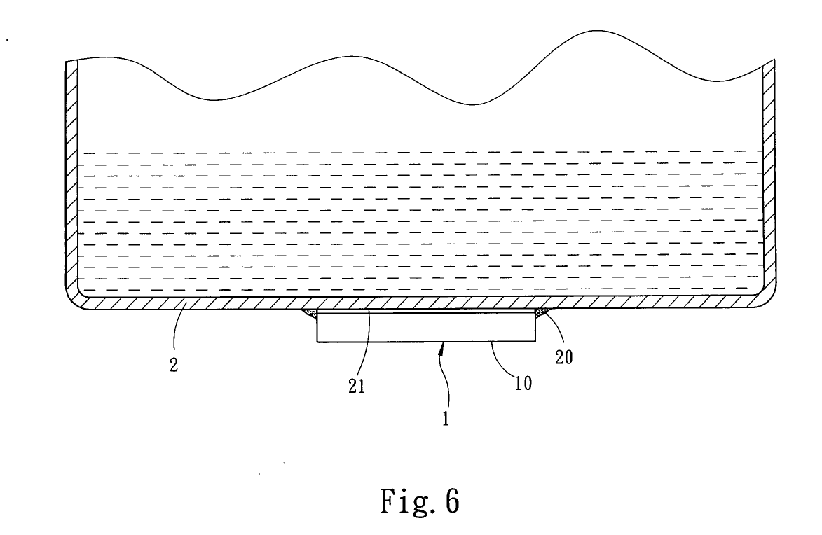

Referring to FIG. 1 for the perspective view of the present invention, the present invention provides an automobile fuel economizer 1 for reducing the gas consumption of an automobile, and the automobile fuel economizer 1 is in form of a box body 10 made of a plastic material or a ceramic material. The box body 10 can contain a substance having a far infrared property, but not limited to any particular arrangement, and the box body 10 is attached onto an automobile fuel tank 2 (as shown in FIG. 6), so that the gas molecules in the fuel tank 2 can exist in a state of being conducted by far infrared radiant energy to make the gas molecules finer and smaller, so that the gas can be combusted and utilized completely, wherein the form of the box body 10 can be adjusted according to the size and specification of the fuel tank 2 and the accommodating space of the automobile.

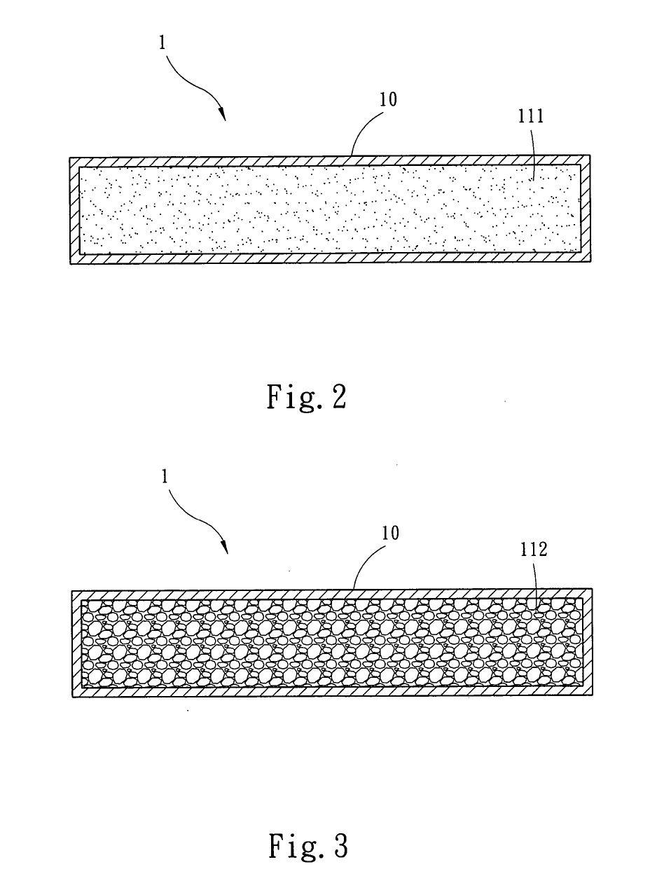

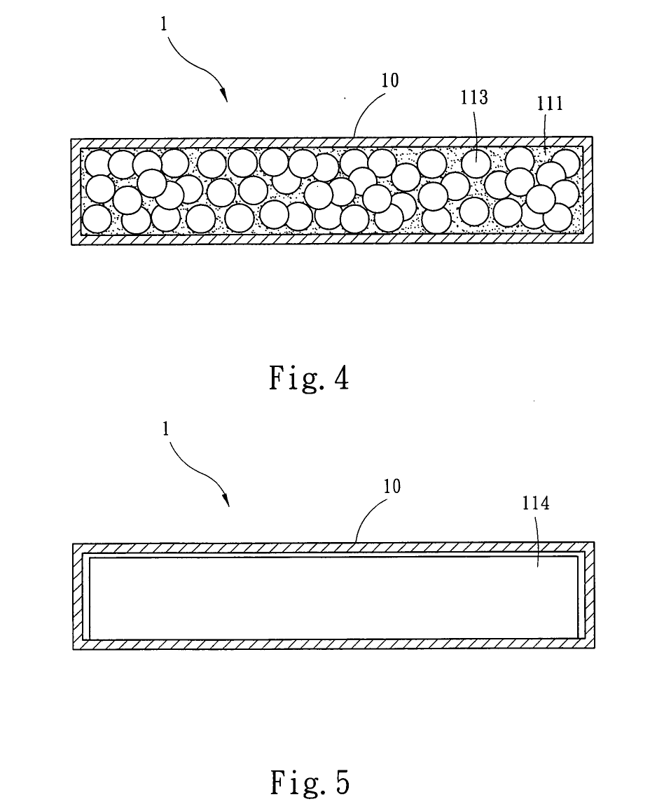

Referring FIGS. 2 to 5 for the cross-sectional views of a preferred embodiment of the present invention, the box body 10 contains a substance having a far infrared property, wherein the substance having a far infrared property is a powder substance 111, a granular substance 112, a spherical substance 113, and a cuboid substance 114 (of which the granular substance 112 and the cuboid substance 114 are also known as lump substance having the far infrared property), or a mixture of the powder substance 111 and the spherical substance 113, or the powder substance 111 compressed into a cuboid substance 114 that is placed in the box body 10. Further, the automobile fuel economizer 1 of the invention can add a catalyst (not shown in the figure) into the box body 10 for catalyzing the substance having a far infrared property and expediting the effect of making the gas molecules finer and smaller.

Referring to FIG. 6 for the schematic view of an automobile fuel economizer being applied to a fuel tank of an automobile according to a preferred embodiment of the present invention, a surface of the box body 10 is attached onto an automobile fuel tank 2 by a double-side tape 20, and the connecting position of the fuel tank 2 and the box body 10 is coated by silicone 21 to prevent the box body 10 from falling apart after a long time of use. In addition, the substance having a far infrared property in the box body 10 passes through the fuel tank 2, so that the gas molecules can absorb sufficient far infrared radiant energy and the gas can be combusted and utilized completely, so as to achieve the purposes of reducing gas consumption, lowering air pollution, enhancing horsepower, and preventing carbon deposition.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An automobile fuel economizer, for reducing the gas consumption of an automobile, comprising a box body, attached onto an automobile fuel tank, and said box body containing a substance having a far infrared property.

2. The automobile fuel economizer of claim 1, wherein said box body is made of a plastic material.

3. The automobile fuel economizer of claim 1, wherein said box body is made of a ceramic material.

4. The automobile fuel economizer of claim 1, wherein said box body can be adjusted according to the specification of said fuel tank and the accommodating space of said automobile.

5. The automobile fuel economizer of claim 1, wherein said box body contains a catalyst.

6. The automobile fuel economizer of claim 1, wherein said substance having a far infrared property is in a powder form.

7. The automobile fuel economizer of claim 1, wherein said substance having a far infrared property is in a lump form of various different shapes.

8. The automobile fuel economizer of claim 1, wherein said substance having a far infrared property is in a spherical form.
